(19) United States
(12) Patent Application Publication
(10) Pub. No.: US 2019/0303128 A1
(43) Pub. Date: Oct. 3, 2019

(54) METHOD FOR INTEGRATING HMI APPLICATION WITH TARGET PLATFORM USING HAAS AND SYSTEM THEREOF

(71) Applicant: Wipro Limited, Bangalore (IN)

(72) Inventors: Debasish Chanda, Maheshtala (IN); Swarup Mandal, Kolkata (IN); Souvik Dutta, Kolkata (IN)

(21) Appl. No.: 15/948,559

(22) Filed: Apr. 9, 2018

(30) Foreign Application Priority Data
Mar. 30, 2018 (IN) 201841012061

(51) Int. Cl. G06F 8/65; G06F 17/30; G06F 8/61

(52) U.S. Cl. CPC G06F 8/65; G06F 17/30864; H04L 67/12; G06F 8/61; G06F 17/30575

(57) ABSTRACT

The present disclosure discloses a method and a system for integrating an update on a HMI application of target platform using HMI as a Service (HaaS). The method comprises receiving a request for updating a HMI application of the target platform. The request comprises request for updating at least one of a view or Business Logic (BL) of the HMI application. Further, the method comprises requesting a HMI Service Delivery Platform (HSDP) to deliver at least one of an updated view and an updated BL for updating the HMI application of the target platform. Further, at least one of the updated view or the updated BL are received from the HSDP, for implementing in the HMI application and integrated with the HMI application, thereby updating the HMI application using HaaS. The present disclosure allows independent testing of the view and the BL.

This application claims the benefit of Indian Patent Application Serial No. 201841012061, filed Mar. 30, 2018, which is hereby incorporated by reference in its entirety.

### FIELD

The present disclosure relates to Human Machine Interface (HMI). More specifically, but not exclusively, the present disclosure relates to a method and a system for integrating an update on a Human Machine Interface (HMI) of a target platform.

### BACKGROUND

Many applications interact with humans with the help of a Human Machine Interface (HMI). HMI development for an application is based on user interface required for the application and business logic. The user interface is also referred as a scene. During a development cycle of the application, a view (for example graphics) of the scene and the business logic may be changed. Hence, the HMI should be changed according to changes in the view and the business logic.

In the existing HMI applications, when the business logic is updated, or a new view is suggested, the entire scene of the HMI application has to be changed. Thus, to achieve productivity, the business logic and the view have to be finalized before developing the HMI application. In few circumstances, the changes required in the view according to changes in the business logic is noticed only when the HMI is developed. Thus, a compromise has to be made to choose either to develop the view initially to avoid changing the HMI, or to change the HMI according to changes in the business logic. The conventional methods update the entire HMI application when only a part of the HMI application requires an update. Updating the entire HMI application requires computation of the HMI application, platform complexities in replacing the HMI application and monetary involvement. Thus, the development and updating the HMI incurs huge amount of resources. Also, plenty of risks are involved while finalizing the view before the HMI development. Thus, the existing systems do not provide proficient system.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure discloses a method for integrating an update on a Human Machine Interface (HMI) application of target platform using HMI as a Service (HaaS). The method comprises receiving, by a target platform, a request for updating a HMI application of the target platform. The request comprises request for updating at least one of a view or Business Logic (BL) of the HMI application. Further, the method comprises requesting a HMI Service Delivery Platform (HSDP) to deliver at least one of an updated view and an updated BL for updating the HMI application of the target platform, where at least one of the HSDP or the target platform generates queries for retrieving at least one of the updated view or the updated BL from a database associated with the HSDP; receiving at least one of the updated view or the updated BL from the HSDP, for implementing in the HMI application; and integrating at least one of the updated view or the updated BL with the HMI application, thereby updating the HMI application using HaaS.

In an embodiment, the present disclosure discloses a target platform for integrating an update on a Human Machine Interface (HMI) application of the target platform using HMI as a Service (HaaS). The target platform comprises a processor and a memory. The processor is configured to receive a request for updating a HMI application of the target platform, where the request comprises request for updating at least one of a view or Business Logic (BL) of the HMI application. The processor is further configured to request a HMI Service Delivery Platform (HSDP) to deliver at least one of an updated view and an updated BL for updating the HMI application of the target platform, where at least one of the HSDP or the target platform generates queries for retrieving at least one of the updated view or the updated BL from a database associated with the HSDP; receive at least one of the updated view or the updated BL from the HSDP, for implementing in the HMI application; and integrate at least one of the updated view or the updated BL with the HMI application, thereby updating the HMI application using HaaS.

In an embodiment, the present disclosure discloses a non-transitory computer readable medium including instructions stored thereon that when processed by at least one processor cause a device to perform operations. The operations comprise receiving a request for updating a HMI application of the target platform. The request comprises request for updating at least one of a view or Business Logic (BL) of the HMI application. Further, the method comprises requesting a HMI Service Delivery Platform (HSDP) to deliver at least one of an updated view and an updated BL for updating the HMI application of the target platform, where at least one of the HSDP or the target platform generates queries for retrieving at least one of the updated view or the updated BL from a database associated with the HSDP; receiving at least one of the updated view or the updated BL from the HSDP, for implementing in the HMI application; and integrating at least one of the updated view or the updated BL with the HMI application, thereby updating the HMI application using HaaS.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The novel features and characteristic of the disclosure are set forth in the appended claims. The disclosure itself, however, as well as a preferred mode of use, further objectives and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates an exemplary HMI framework for integrating an update on HMI application of a target platform, in accordance with some embodiments of the present disclosure;

FIG. 2 shows an exemplary block diagram of a target platform, in accordance with some embodiments of the present disclosure;

FIG. 3 shows an exemplary flow chart illustrating method steps for integrating an update on HMI application of a target platform, in accordance with some embodiments of the present disclosure;

FIG. 4a is an example illustrating data hierarchy levels in a view DB, in accordance with some embodiments of the present disclosure;

FIG. 4b is an example illustrating functions associated with a BL DB, in accordance with some embodiments of the present disclosure;

FIG. 5a shows an exemplary flow chart illustrating integration of view to a target platform, in accordance with some embodiments of the present disclosure;

FIG. 5b shows an exemplary flow chart illustrating integration of BL to a target platform, in accordance with some embodiments of the present disclosure;

FIGS. 6a, 6b, and 6c show an exemplary flow chart for illustrating steps of implementing a view, updating a view and state implementation in a HMI application, in accordance with some embodiments of the present disclosure;

FIGS. 7a, 7b, and 7c are example illustrations of implementation of HMI application integrated in a target platform;

FIGS. 8a, 8b, and 8c are example illustrations of implementation of HMI application integrated in a target platform; and

FIG. 9 shows a general-purpose computing system for integrating an update on HMI application of the target platform, in accordance with some embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure may relate to a method and a system for integrating a Human Machine Interface (HMI) application with a target platform. In an embodiment, the target platform may comprise the HMI application. Alternatively, the target platform may not comprise the HMI application. The target platform (for example a mobile device) may receive a request from a user to update one of a view or Business Logic (BL) of the HMI application. In an embodiment, update may refer to add or change elements or components to already existing HMI application in the target platform. In an embodiment, update may refer to integration of the entire HMI application in the target platform. The target platform may generate queries according to the request. The queries may include a request for retrieving at least one of a view and a BL from a view database and a BL database respectively. The queries may be provided to a HMI Service Delivery Platform (HSDP). The HSDP may be configured to fetch the view and the BL from the view DB and the BL DB respectively. In an embodiment, the view and the BL in the view DB and the BL DB respectively may be referred as updated view and updated BL hereafter in the present disclosure. The HSDP may provide the updated view or the updated BL to the target platform upon retrieving from the view DB and the BL DB. Thereafter, the target platform integrates the updated view or the updated BL.

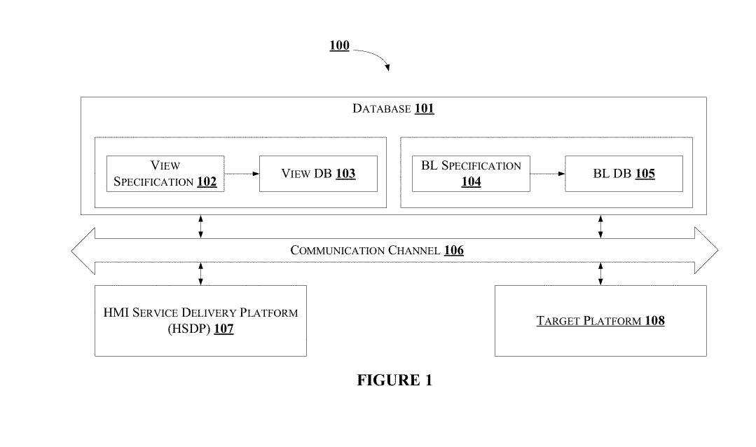

FIG. 1 illustrates an exemplary framework for integrating an update on Human Machine Interface (HMI) application (not shown) to a target platform (108). The framework comprises a database (101) (DB), view specification (102), a view DB (103), a Business Logic (BL) specification (104), a BL DB (105), a communication channel (106), a HMI Service Delivery platform (HSDP) (107) and a target platform (108). In an embodiment, the DB (101) may be connected to the target platform (108) via the communication channel (106). The view specification (102) may comprise details regarding a view, a logic associated with the view, graphics, theme, color details, and the like required for developing the scene of the HMI application. In an embodiment, the view specification (102) may be provided by a view specification source (not shown). The logic associated with the view may define start-up procedure of the HMI application and progression and prioritization of the animations in the HMI application (for example, an animation to show increase in volume). In an embodiment, the scene specification input source may be any source capable of provisioning a scene specification in at least one of a text format, a Visio™ format, a graphical format and the like. In an embodiment, the scene specification source may be an Original Equipment Manufacturer (OEM). In an embodiment, the BL specification (104) may comprise details regarding the BL required for the HMI application. The BL may comprise logic of the HMI application and logic of a view of the HMI application. The logic of the HMI application may define an interaction with a user using the HMI application (for example, logic for a user to change volume of an infotainment system). In an embodiment, the BL specification (104) input source may be any source capable of provisioning a BL specification (104) in at least one of a text format, a Visio™ format, and the like. In an embodiment, the BL specification (104) source may be an Original Equipment Manufacturer (OEM). In an embodiment, the view DB (103) and the BL DB (105) may be developed using the view specification (102) and the BL specification (104) respectively. In an embodiment, the view DB (103) and the BL DB (105) may be dynamic, i.e., when the view specification (102) and the BL specification (104) are updated, the view DB (103) and the BL DB (105) are automatically updated.

In an embodiment, the HSDP (107) may deliver the HMI application which is reconfigurable (i.e., the HMI application and subsequent updates on the HMI application) to the target platform (108). In one embodiment, the HMI application is also referred as reconfigurable HMI application in the present disclosure. In an embodiment, the HSDP (107) may use cloud-based service to deliver the HMI application to the target platform (108). Consequently, the HSDP (107) may deliver the updated view or the updated BL to the target platform (108). The HSDP (107) may communicate with the view DB (103) and the target platform (108) via the communication channel (106). The communication channel (106) may be any wired or wireless communication network (909) (e.g., local area network (LAN), wireless LAN (WLAN), wide area network (WAN), Internet, etc.) or a wired or wireless communication medium (e.g., serial port, universal serial bus (USB), Bluetooth, etc). Examples of HSDP (107) may include Weston™, OpenGL™/EG™, ALSA™.

The target platform (108) is also referred as Device Under Test (DUT) (108) in the present disclosure. In an embodiment, the DUT (108) may receive requests from a user through a user interface or communication interface configured in the DUT (108). For example, the user interface may include, but is not limited to, a microphone, a touch screen, a keypad, and the like. The DUT (108) may generate queries for retrieving the updated view or the updated BL from the view DB (103) and the BL DB (105) respectively. Further, the DUT (108) may receive the reconfigurable HMI application from the HDSP. The reconfigurable HMI application may comprise the updated view or the updated BL. The updated view or the updated BL are decoupled in the DUT (108). Further, the updated view or the updated BL are integrated in the DUT (108).

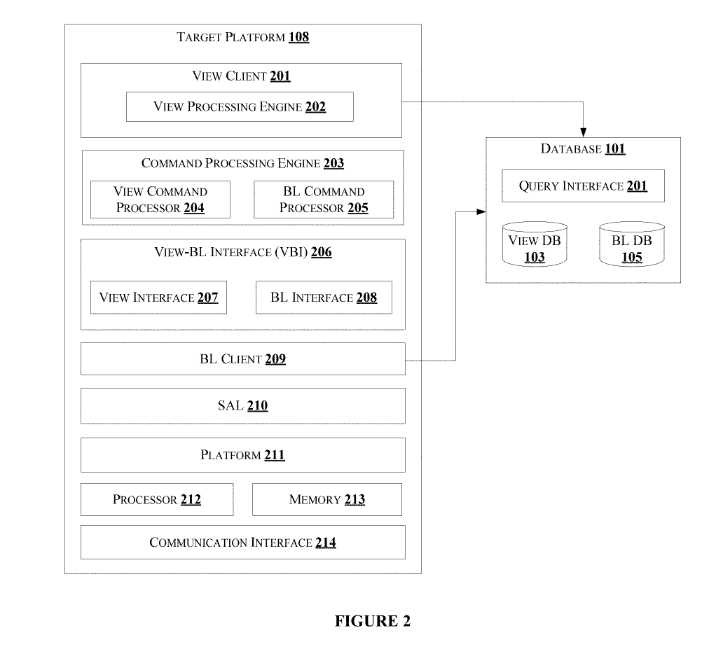

Referring now to FIG. 2, an exemplary block diagram of a target platform (108) or DUT (108) is shown, in accordance with some embodiments of the present disclosure. The DUT (108) comprises a view client (201), a Command Processing Engine (CPE) (203), a View-BL interface (VBI) (206), a BL client (209), a Service Access Layer (SAL) (210), a platform (211), a processor (212), a memory (213) and a communication interface (214).

In an embodiment, the view client (201) comprises a View Processing Engine (VPE) (202). The VPE (202) may generate the queries for retrieving the updated view from the view DB (103). The VPE (202) may render the screen of the DUT (108) using reference VPE (202) plug-in specific to the DUT (108). The reference VPE (202) plug-in may include, but is not limited to, Enlightenment Foundation Libraries (EFL)™, QT™, GTK™, Android™, Chrome™, IOS™, Windows™, etc. A screen in the HMI application may comprise plurality of components. Each component may be provided an identity (ID) and is stored in a data pool. When the VPE (202) requests for an update in the view, the view DB (103) may provide the updated view to the data pool. The data pool may associate a unique ID to the updated view. The VPE (202) may fetch the updated view from the data pool based on ID of the current view and the updated view.

In an embodiment, the Command Processing Engine (CPE) (203) processes commands exchanged between the view client (201) and the BL client (209) via the VBI (206). CPE (203) facilitates communication between the BL client (209) and the View client (201). View client (201) may provide the BL client (209) with information about the user input event (for example: “X” button is clicked). The view client (201) may form a message (for example JSON or XML format) to communicate with the BL client (209) via inter-process-communication (such as socket or message queue) enabled by the CPE (203). Similarly, BL client (209) may provide the view client (201) information about a view action (such as open new screen or update text component). The CPE (203) comprises a View Command Processor (VCP) (204) and BL command processor (205). The VCP (204) may build a message corresponding to a user input (for example message for “x” button clicked) and communicate to the BL client (209). The BL command processor (205) receives BL messages and parses to understand a view action required (such as update text box or create new screen). Further, the BL command processor (205) may query the BL DB (105) for appropriate BL update.

In an embodiment, the View-BL Interface (VBI (206)), the BL client (209), the Service Access Layer (SAL) (210) and the platform (211) may be modules inside the processor (212). In an embodiment, the memory (213) may comprise data (not shown). The data may include but not limited to, set of queries, DUT (108) requirements, etc. In an embodiment, the set of queries may be instructions to retrieve the updated view or the updated BL from the view DB (103) and the BL DB (105) respectively. In an embodiment, the DUT (108) requirements may include data related to technologies compatible with the DUT (108), screen resolution, hardware components associated with the DUT (108) and the like.

The view client (201) may be used for visualizing a screen of the HMI application. The screen of the HMI application may include the VBI (206), the BL client (209) and the SAL (210). The BL client (209) may include control logic for controlling and functioning of the HMI application.

In an embodiment, the VBI (206) may be defined using an XML schema. Further, the VBI (206) and the CPE (203) may decouple the view client (201) from the BL client (209). The VBI (206) may comprise a view interface (207) and a BL interface (208). The view interface (207) may be associated with the view client (201) and the BL interface (208) may be associated with the BL client (209). The view interface (207) and the BL interface (208) may together form the VBI (206). In an embodiment, the VBI (206) may form a common bridge between the view client (201) and the BL client (209).

The SAL (210) may be an interface that may decouple the BL client (209) from the platform (211). In an embodiment, the SAL (210) may use an XML based schema to define the interface between the BL client (209) and the platform (211). The platform (211) may include platform (211) specific services encapsulated in a platform (211) layer (a layer hosting the platform (211)).

As shown in the FIG. 2, the view client (201) and the BL client (209) may interact with the database (101). The view client (201) may generate queries for retrieving an updated view from the view DB (103). Likewise, the BL client (209) may generate queries for retrieving updated BL from the BL DB (105). In an embodiment, the queries generated by the view client (201) and the BL client (209) may be received by a query interface configured in the database (101). The query interface may then query the respective DB (101) to retrieve respective data.

In an embodiment, the communication interface (214) facilitates overall communication between components in the DUT (108). In an embodiment, the communication interface (214) may also facilitate interaction of the DUT (108) with the user and the DB (101).

In an embodiment, the BL client (209) may comprise a view adaptor, an event translator and a control processor. The view adaptor may facilitate communication of the BL client (209) with the view client (201) via the VBI (206). The event translator may analyze user-initiated events received from the view client (201) and system-generated events received from the SAL (210). The user-initiated events and the system-initiated events are then translated into logical events. The control processor (212) may query the BL DB (105) based on the logical events generated by the event translator.

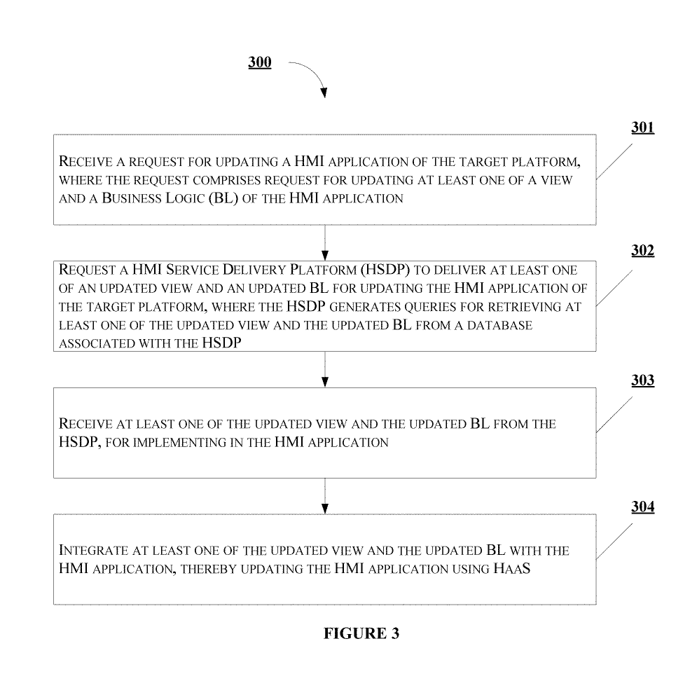

FIG. 3 shows an exemplary flow chart illustrating method (300) steps for integrating an update for HMI application of a target platform (108), in accordance with some embodiments of the present disclosure.

As illustrated in FIG. 3, the method 300 may comprise one or more steps for integrating the HMI application with the DUT (108), in accordance with some embodiments of the present disclosure. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At step 301, the communication interface (214) of the DUT (108) may receive a request from the user for updating the HMI application. Specifically, the request may refer to updating the view and the BL of the HMI application. In an embodiment, the request for updating the view and the BL may be generated based on user inputs. For example, when a driver of a vehicle provides an input for changing audio mode from radio to Bluetooth in a HMI application configured in the vehicle, the HMI application may request for an updated view and corresponding BL for displaying Bluetooth settings. Request related to the view may be directed to the view client (201) and the request related to the BL may be directed to the BL by the communication interface (214).

At step 302, the view client (201) and the BL client (209) may generate queries for retrieving the updated view or the updated BL from the view DB (103) and the BL DB (105). The view client (201) and the BL client (209) may then request the intermediate HSDP (107) to deliver the updated view or the updated BL from the database (101). In an embodiment, the HSDP (107) may generate the queries based on the request made by the view client (201) and the BL client (209). The HSDP (107) retrieves the updated view or the updated BL from the view DB (103) and the BL DB (105). The HSDP may be a cloud-based service provider providing service for delivering updated view or the updated BL from the view DB and the BL DB (105) respectively.

At step 303 the communication interface (214) may receive the updated view or the updated BL from the HSDP (107). The communication interface (214) may follow Open Mobile Alliance-Data Synchronization (OMA-DS) protocol for receiving the updated view or the updated BL from the HSDP (107). The updated view or the updated BL are received as packages by the communication interface (214). Further, the communication interface (214) may provide the package to the VBI (206). The VBI (206) may decouple the updated view or the updated BL and provide respective data to the view client (201) and the BL client (209). The CPE (203) may process the updated view or the updated BL communicated by the VBI (206) to the view client (201) and the BL client (209).

At step 304 the updated view or the updated BL are implemented in the HMI application. The VPE (202) of the view client (201) may integrate the updated view with an existing view in the HMI application. The updated view may be associated with corresponding BL. When the BL may be implemented, the corresponding view is rendered on the screen of the DUT (108). Likewise, the BL client (209) integrates the updated BL with an existing BL in the HMI application.

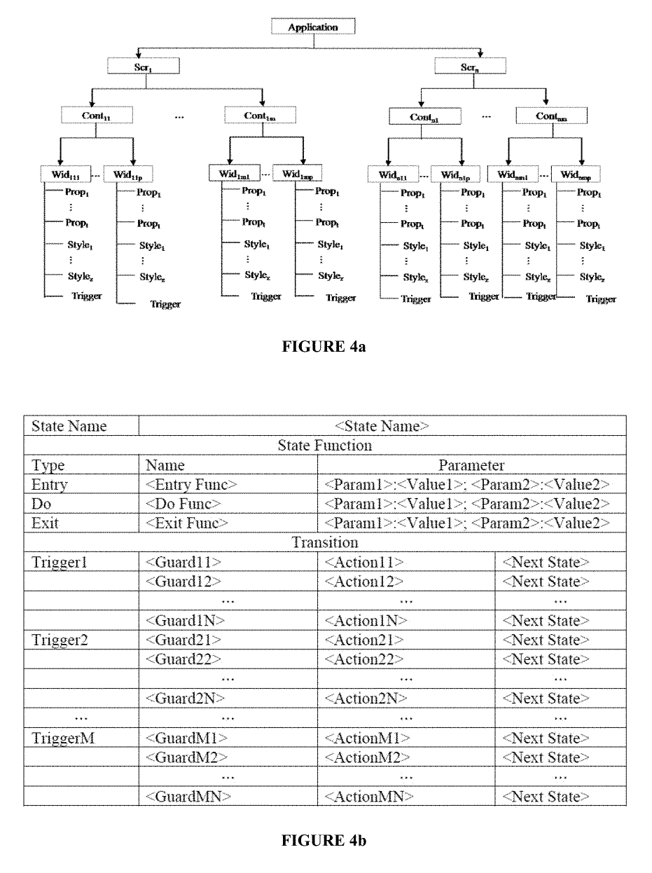

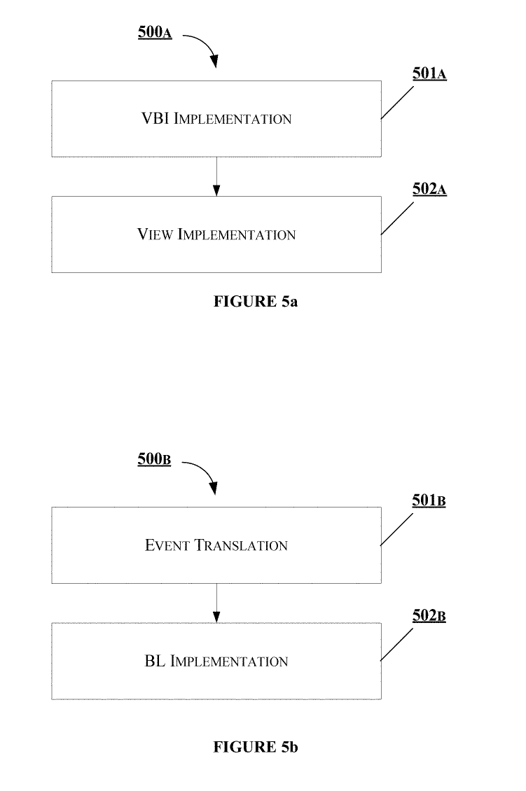

FIG. 4a is an example illustrating data hierarchy layers in a view DB (103), in accordance with some embodiments of the present disclosure. For example, in a first layer, the screen may be divided into one or more containers. In an embodiment, each of the one or more containers may be divided into one or more sub-containers (not shown). Likewise, a second layer may be divided into the one or more containers. In the second layer, each of the one or more containers may contain one or more widgets. A unique Object Identity (OID) may be assigned to each of the one or more containers and the one or more widgets. The unique OID may have a prefix based on the one or more containers or a widget type.

FIG. 4b is an example illustrating functions associated with a BL DB (105), in accordance with some embodiments of the present disclosure. The BL DB (105) may be generated from the BL specification (104) by generating a state chart. The state chart may comprise one or more states and transition from one state to another state. A guard condition may be present between any transitions from one state to another state. Guard conditions may be Boolean expressions evaluated dynamically based on state variables and event parameters. The guard conditions may affect the behavior of a state by enabling actions or transitions only based on predefined conditions. The actions may include at least one of an entry function, an exit function, a transition function and a do function. In an embodiment, the entry function is executed when a transition occurs from one state to another state. In an embodiment, the do function may be executed when a continuous process is performed on a current state. In an embodiment, the exit function may be executed on a state when a transition occurs from the state to another state. In an embodiment, the transition function may comprise a guard condition, an action function and a next state, for every trigger initiated. FIG. 4B represents the table format of the state chart. The table format of the state chart may be used for generating the BL DB (105) from the state chart. The table format of the state chart may be used for developing a similar table in the BL DB (105).

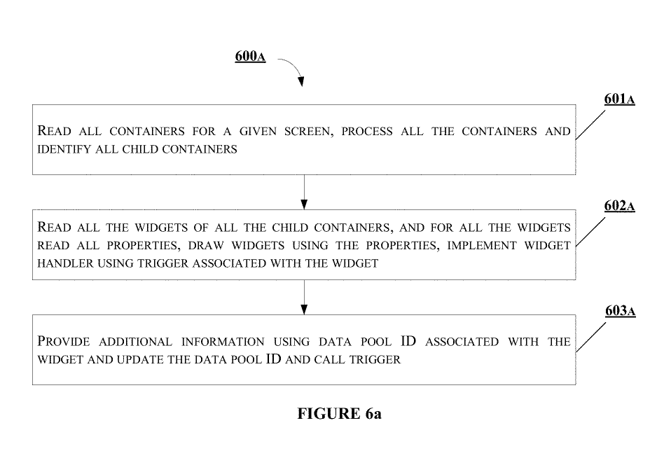

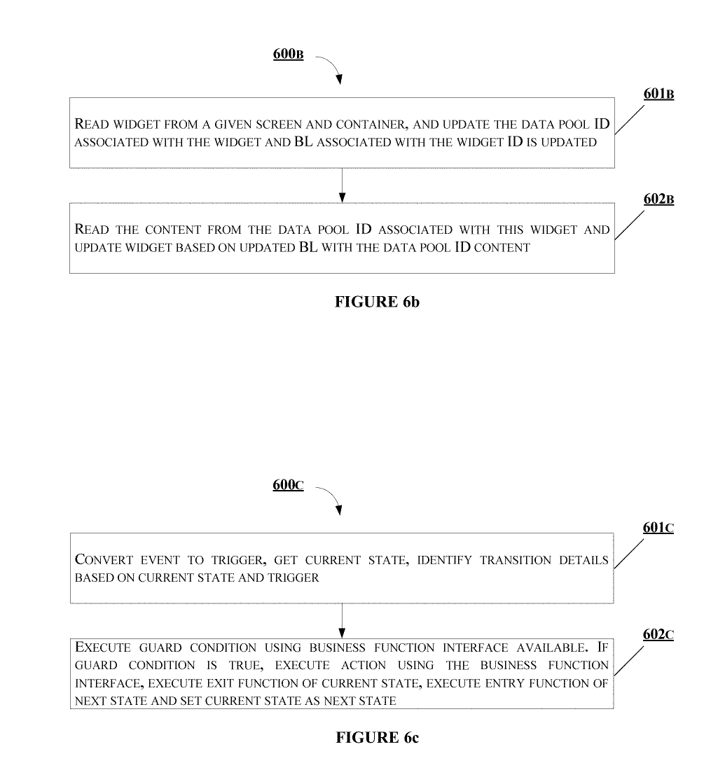

FIG. 5a shows an exemplary flow chart 500a illustrating integration of view to a target platform (108), in accordance with some embodiments of the present disclosure.

At step 501a, the VBI (206) may be developed according to a VBI (206) interface. A platform (211) specific Inter-Process-Communication (IPC) interface may be used to inform the BL about the user input. A trigger name may be retrieved from a trigger table associated with the view DB (103) for related one or more widgets using the queries. Also, extra augmented information may be shared using the OID associated with the one or more widgets. The business logic may update the view about drawing new screen or components. The new screen or components may be updated using the IPC interface provided by the business logic to inform the view about the view action requested.

At step 502a, the view may be implemented based on the business logic and the scene data specified in the view specification (102).

FIG. 5b shows an exemplary flow chart 500b illustrating integration of BL to a target platform (108), in accordance with some embodiments of the present disclosure.

At step 501b, the event translator may be responsible for analyzing the user-initiated events and system-initiated events. The event translator may further translate the events into logical events for further processing by the control processor (212).

At step 502b, the control processor (212) may be responsible for querying the BL DB (105) and may implement the BL based on the logical events.

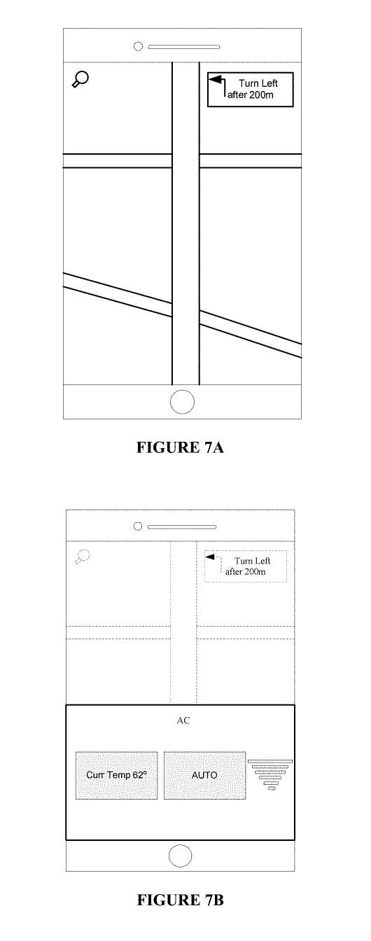

FIG. 6a shows a flow chart 600a illustrating updating a screen of the HMI application, in accordance with some embodiments of the present disclosure.

At step 601a, the VPE (202) reads al containers for a given screen, processes all the containers and identifies all child containers in the screen. In an embodiment, each component, graphical User Interface (GUI)/screen and widgets in the screen are associated with a corresponding identity (ID). The ID of each container, GUI and widget is stored in the data pool associated with the DUT (108). When the screen has to be updated, the VPE (202) reads all the containers, and the child containers present in a current screen.

At step 602a, the VPE (202) reads all widgets of each child container. Further, the VPE (202) may save the screen with corresponding GUI ID in the data pool. Further, when the VPE (202) queries the view BL (103) for updated screen, the view BL (103) provides the updated screen along with GUI ID of the updated screen to the data pool. The VPE (202) may read all properties of the widgets and may store the properties of the widget along with widget ID in the data pool.

At step 603a, the VPE (202) may retrieve the updated screen from the data pool and call for a trigger. The trigger may provide an action for a transition from the current screen to the updated screen. The VPE (202) may draw widgets for updated screen using the properties of current screen. In an embodiment, the widgets may be drawn using IDs associated with updated screen. In an embodiment, a widget handler may be implemented using a trigger associated with the widget.

FIG. 6b shows a flow chart illustrating updating components of the HMI application, in accordance with some embodiments of the present disclosure.

At step 601b, the BL client (209) may update the data pool with an ID for a BL associated with a widget ID in the data pool. When the view is updated, the BL associated with the view may also be updated. Each container, widget that may be updated, may also correspond to an update in the BL. The VCP (204) may build a message corresponding to a user input and communicate to the BL client (209).

At step 602b, the widget contents associated with the widgets are updated when the updated BL is retrieved from the BL DB (105). The BL command processor (205) receives BL messages and parses to understand a view action required (such as update text box or create new screen). Further, the BL command processor (205) may query the BL DB (105) for appropriate BL update. The updated components and a corresponding updated BL are stored in the data pool along with corresponding IDs. The BL client (209) may retrieve the BL associated with the updated view for integrating in the HMI application. Here, for the updated BL, the view is also updated, and corresponding IDs are updated in the data pool. Thus, when the updated BL may be retrieved by the BL client (209), corresponding updated view may be retrieved by the VPE (202).

FIG. 6c shows a flow chart 600c illustrating updating state of the screen of the HMI application, in accordance with some embodiments of the present disclosure.

At step 601c, an event is converted to a trigger, a current status of the screen is received and transitions details between states are identified based on the current state and the trigger. When the BL is updated, a state related to an event is also updated (for example: when user clicks “X” button, a radio broadcast mode may be changed to video mode). The BL client (209) may store information about events and states in a table as illustrated in FIG. 4b. The BL client (209) may map a state with another state indicating a transition between the states. A state diagram (not shown) may be generated by the BL client (209) to traverse different state transitions. The BL client (209) may record a current state of the HMI application and retrieves information about a next state based on the updated BL.

At step 602c, a guard condition is executed using business function interface. A guard condition may be established to provide a guard interval between transitions of a current state to the next state. Further, the BL client (209) may execute one or more actions based on the updated BL. Thereafter, the BL client (209) may execute an exit function on the current state and execute an entry function to the next state.

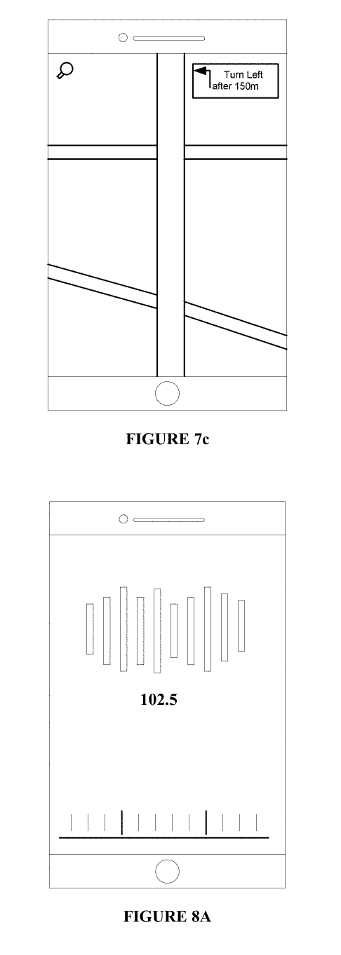

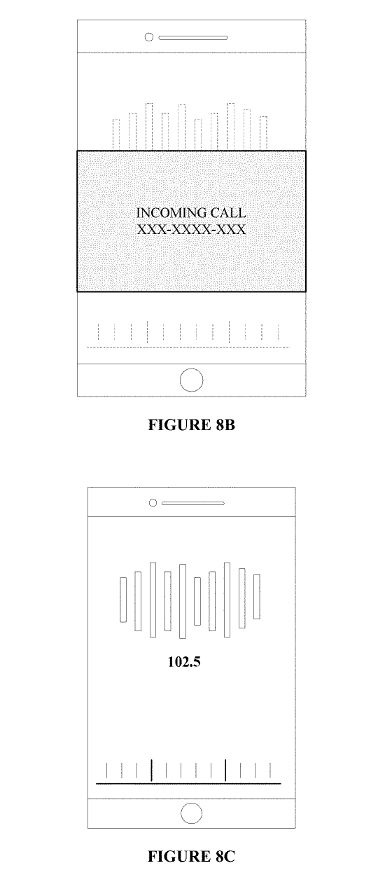

FIGS. 7a, 7b, 7c, 8a, 8b and 8c are example illustrations of implementation of HMI application integrated in a target platform (108).

Reference is now made to FIG. 7a. Consider a vehicle configured with a HMI application. As shown in FIG. 7a, a navigation screen is shown to a driver/passenger. The navigation screen may only show a visual representation of a map showing directions from a source to a destination. Thus, let us assume that speakers and microphone of the vehicle are disabled. In a scenario where the driver/passenger may have to change Air Conditioning (AC) settings of the vehicle, the driver/passenger may have to provide input to the HMI application. This scenario may be user generated event. When the user provides inputs for changing the AC setting for changing temperature from 62-degree Fahrenheit to 64-degree Fahrenheit, the screen of the HMI application may be updated showing the AC settings. The HMI application may immediately query the view DB (103) and BL DB (105) associated with the HMI application. In an embodiment, the HMI application may be directly coupled with the view DB (103) and the BL DB (105). When the HMI application retrieves the updated view or the updated BL related to changing the AC settings, the screen of the HMI application may be as represented in FIG. 7b. FIG. 7b shows the AC settings and related information. The related information may include temperature inside the vehicle, temperature outside the vehicle, number of air vents active, direction of air flow and the like. The related information may be the updated view. When the driver/passenger inputs for changing the temperature, the HMI application may retrieve updated BL for implementing the change in temperature. The updated BL may include control logic for implementing the change from 62-degree Fahrenheit to 64-degree Fahrenheit. In this scenario, the screen showing the AC settings may be for a predefined time period. Thus, prior updating the view and the BL, the HMI application may store the existing view and BL in a buffer or the memory (213). When the AC settings are changed, the view may return to the previous settings displaying navigation. Thus, the HMI application may retrieve the view and BL associated with the navigation and may resume the navigation as shown in FIG. 7c.

Reference is now made to FIG. 8a. Consider a vehicle configured with a HMI application. As shown in FIG. 8a, a screen may be presenting a radio. The radio may have visual representation on the screen and may enable all speakers of the vehicle. Assume a scenario, where a driver/passenger receives a call, and a mobile device of the driver/passenger is associated with the HMI application. This scenario may be a system generated event. Here, the HMI application may have to display a screen showing a number or contact of a caller. The HMI application may have to query the view DB (103) and the BL DB (105) coupled with the HMI application. The screen may have to display the caller identity or number. Thus, the HMI application may render the updated view for displaying the caller. Further, the HMI application may have to disable all the speakers and enable at least one speaker closer to the driver/passenger. Also, the HMI application may have to enable a microphone of the HMI application. Thus, the HMI retrieves BL related to displaying a caller on the screen and an event of the driver/passenger answering the caller. FIG. 8b shows a representation where the HMI application displays a caller number on the screen. In this scenario, the screen showing the caller details may be for a predefined time period. Thus, prior updating the view and the BL, the HMI application may store the existing view and BL in a buffer or the memory (213). When the call is ended, the view may return to the previous settings displaying radio and enabling all the speakers. Thus, the HMI application may retrieve the view and BL associated with the radio and may resume the radio as shown in FIG. 8c.

In an embodiment, the present disclosure discloses a DUT (108) for integrating updates in the HMI application of the DUT (108). The view and the BL are decoupled, thus enabling independent integration of the view and the BL.

In an embodiment, the view and the BL may be independently tested. As the view and the BL are decoupled, testing of the view and the BL can be performed simultaneously.

In an embodiment, a requirement in updating the view or the BL may not require updating the entire HMI application. The present disclosure provisions updating the view and the BL independently.

### Computer System

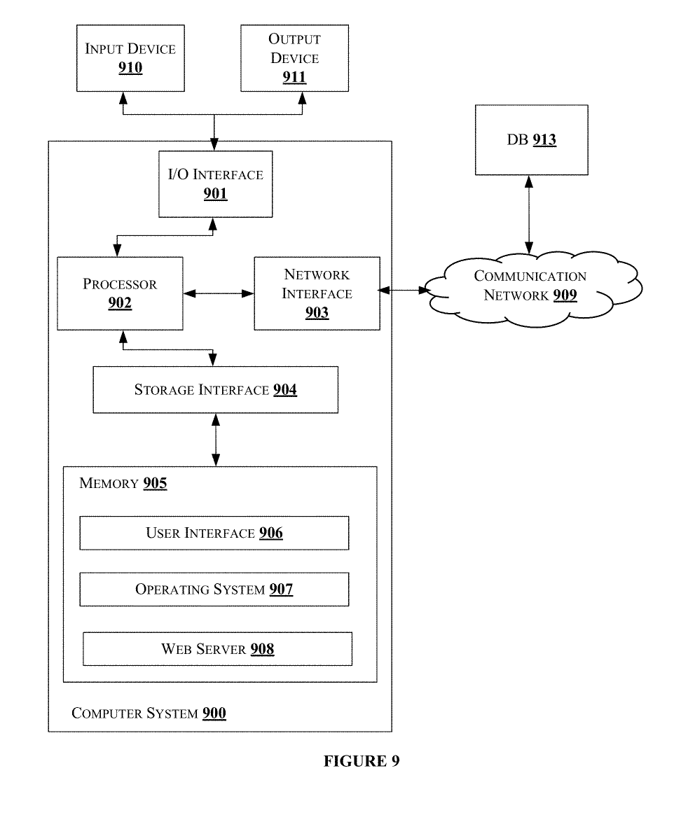

FIG. 9 illustrates a block diagram of an exemplary computer system 900 for implementing embodiments consistent with the present disclosure. In an embodiment, the computer system 900 is used to implement integrating the HMI application with the DUT. The computer system 900 may comprise a central processing unit (“CPU” or “processor”) 902. The processor 902 may comprise at least one data processor for integrating the scene DB with the HMI application. The processor 902 may include specialized processing units such as integrated system (bus) controllers, memory management control units, floating point units, graphics processing units, digital signal processing units, etc.

The processor 902 may be disposed in communication with one or more input/output (I/O) devices (not shown) via I/O interface 901. The I/O interface 901 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 901, the computer system 900 may communicate with one or more I/O devices. For example, the input device 910 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 911 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor 902 may be disposed in communication with the communication network 909 via a network interface 903. The network interface 903 may communicate with the communication network 909. The network interface 903 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 909 may include, without limitation, a direct interconnection, local area network (LAN), wide area network (WAN), wireless network (e.g., using Wireless Application Protocol), the Internet, etc. Using the network interface 903 and the communication network 909, the computer system 900 may communicate with the scene specification input sources 912 and the DB 913. The network interface 903 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 909 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 902 may be disposed in communication with a memory 905 (e.g., RAM, ROM, etc. not shown in FIG. 9) via a storage interface 904. The storage interface 904 may connect to memory 905 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 905 may store a collection of program or database components, including, without limitation, user interface 906, an operating system 907, web server 908 etc. In some embodiments, computer system 900 may store user/application data 906, such as, the data, variables, records, etc., as described in this disclosure. Such databases may be implemented as fault-tolerant, relational, scalable, secure databases such as Oracle® or Sybase®.

The operating system 907 may facilitate resource management and operation of the computer system 900. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the computer system 900 may implement a web browser 908 stored program component. The web browser 908 may be a hypertext viewing application, for example MICROSOFT® INTERNET EXPLORER™, GOOGLE® CHROME™°, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 908 may utilize facilities such as AJAX™, DHTML™, ADOBE® FLASH™, JAVASCRIPT™, JAVA™, Application Programming Interfaces (APIs), etc. In some embodiments, the computer system 900 may implement a mail server stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 600 may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 3, 5 and 6 show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for integrating an update on a Human Machine Interface (HMI) application of target platform using HMI as a Service (HaaS), comprising:
receiving, by a target platform, a request for updating a HMI application of the target platform, wherein the request comprises request for updating at least one of a view and a Business Logic (BL) of the HMI application wherein the view and the BL associated with the target platform are decoupled;
requesting, by the target platform, a HMI Service Delivery Platform (HSDP) to deliver at least one of an updated view and an updated BL for updating the HMI application of the target platform, wherein at least one of the HSDP and the target platform generates queries for retrieving at least one of the updated view or the updated BL from a database associated with the HSDP, wherein the updated view and the updated BL are generated based on a view specification and a BL specification respectively, wherein the view specification comprises details regarding a view and a logic associated with the view required for developing a scene of the HMI application and wherein the BL specification comprises details regarding the BL required for the HMI application;
receiving, by the target platform, at least one of the updated view or the updated BL from the HSDP, for implementing in the HMI application; and
integrating, by the target platform, at least one of the updated view or the updated BL with the HMI application, thereby updating the HMI application using HaaS.

2. The method of claim 1, wherein the target platform receives at least one of the updated view or the updated BL as a package from the HSDP.

3. The method of claim 2, wherein the target platform receives the package from the HSDP using an Open Mobile Alliance-Data Synchronization (OMA-DS) protocol.

4. (canceled)

5. The method of claim 1, wherein updating further comprises installing the updated view or the updated BL in the target platform.

6. A target platform for integrating an update on a Human Machine Interface (HMI) application of the target platform using HMI as a Service (HaaS), comprising:
a processor; and
a memory, communicatively coupled to the processor, which stores processor executable instructions, which on execution causes the processor to:
receive a request for updating a HMI application of the target platform, wherein the request comprises request for updating at least one of a view or Business Logic (BL) of the HMI application wherein the view and the BL associated with the target platform are decoupled;
request a HMI Service Delivery Platform (HSDP) to deliver at least one of an updated view and an updated BL for updating the HMI application of the target platform, wherein at least one of the HSDP and the target platform generates queries for retrieving at least one of the updated view or the updated BL from a database associated with the HSDP, wherein the updated view and the updated BL are generated based on a view specification and a BL specification respectively, wherein the view specification comprises details regarding a view and a logic associated with the view required for developing a scene of the HMI application and wherein the BL specification comprises details regarding the BL required for the HMI application;
receive at least one of the updated view or the updated BL from the HSDP, for implementing in the HMI application; and
integrate at least one of the updated view or the updated BL with the HMI application, thereby updating the HMI application using HaaS.

7. The target platform of claim 6, is configured to receive at least one of the updated view or the updated BL as a package from the HSDP.

8. The target platform of claim 7, is configured to receive the package from the HSDP using an Open Mobile Alliance-Data Synchronization (OMA-DS) protocol.

9. (canceled)

10. The target platform of claim 6, wherein the processor integrates the updated view or the updated BL by installing the updated view or the updated BL in the target platform.

11. A non-transitory computer readable medium including instructions stored thereon that when processed by at least one processor cause a device to perform operations comprising:
receiving a request for updating a HMI application of the target platform, wherein the request comprises request for updating at least one of a view or a Business Logic (BL) of the HMI application wherein the view and the BL associated with the target platform are decoupled;
requesting a HMI Service Delivery Platform (HSDP) to deliver at least one of an updated view and an updated BL for updating the HMI application of the target platform, wherein at least one of the HSDP and the target platform generates queries for retrieving at least one of the updated view or the updated BL from a database associated with the HSDP, wherein the updated view and the updated BL are generated based on a view specification and a BL specification respectively, wherein the view specification comprises details regarding a view and a logic associated with the view required for developing a scene of the HMI application and wherein the BL specification comprises details regarding the BL required for the HMI application;
receiving at least one of the updated view or the updated BL from the HSDP, for implementing in the HMI application; and
integrating at least one of the updated view or the updated BL with the HMI application, thereby updating the HMI application using HaaS.

12. The non-transitory computer readable medium of claim 11, wherein target platform receives at least one of the updated view or the updated BL as a package from the HSDP.

13. The non-transitory computer readable medium of claim 12, wherein the target platform receives the package from the HSDP using an Open Mobile Alliance-Data Synchronization (OMA-DS) protocol.

14. (canceled)

15. The non-transitory computer readable medium of claim 11, wherein the updating further comprises installing the updated view or the updated BL in the target device.
